(19) United States
(12) Patent Application Publication
(10) Pub. No.: US 2013/0266850 A1
(43) Pub. Date: Oct. 10, 2013

(54) ELECTROCHEMICAL CELL AND METHOD FOR MANUFACTURING SAME

(71) Applicant: Claus-Rupert Hohenthanner, Hanau (DE)

(72) Inventor: Claus-Rupert Hohenthanner, Hanau (DE)

(73) Assignee: Li-Tec Battery GmbH, Kamenz (DE)

(21) Appl. No.: 13/882,445

(22) PCT Filed: Oct. 27, 2011
(86) PCT No.: PCT/EP11/05432

§ 371 Date: Jun. 26, 2013

(30) Foreign Application Priority Data
Oct. 29, 2010 (DE) 10 2010 050 046.1

(51) Int. Cl. H01M 2/08

(52) U.S. Cl. CPC H01M 2/08
USPC 429/185; 29/623.2

(57) ABSTRACT

An electrochemical cell (100) comprises at least one electrode stack (150) having at least one conductor device (110) and at least one casing (130). The casing (130) at least partially encases the electrode stack (150) and has at least one passage section (140) for the least one conductor device (110) from the interior to the exterior of the casing. At least one protective device (120) is disposed at this passage section (140) to maintain a substantially fluid-tight property of the casing (130) in the area of this passage section (140), i.e. to minimize the danger of damaging the casing (130) and/or its sealing seam in the area of this passage section (140).

The present invention relates to an electrochemical cell comprising an electrode stack having a conductor device and at least one casing through which the conductor device passes. The present invention further relates to a method for manufacturing such an electrochemical cell.

One important aspect when operating electrochemical cells, particularly battery cells or secondary battery cells, particularly high-capacity battery cells of e.g. traction, hybrid or starter batteries for electric and hybrid vehicles, batteries for uninterruptible power supply (UPS) and solar batteries, and particularly in the case of secondary lithium-based battery cells, is that reliable battery operation needs to be ensured for a specific battery life. Such a battery is known for example from EP 1 394 874 B1.

However, error-free functioning of the batteries also needs to be ensured under adverse operating conditions as, for example, upon severe “mechanical” loads. Under such operating conditions, the conductor device protruding from the casing can damage the casing, whereby electrolyte liquid can leak out, for example, or a casing short circuit can occur.

The invention is thus based on the object of providing an improved electrochemical cell.

This is achieved according to the invention by the teaching of the independent claims. Preferential further developments of the invention constitute the subject-matter of the subclaims.

As the following will describe in detail, an electrochemical cell comprising at least one electrode stack having at least one conductor device and at least one casing is provided to accomplish the given object. The casing at least partially encases the electrode stack and comprises a passage section—from the interior to the exterior of the casing—for the at least one conductor device. In accordance with the invention, the electrochemical cell is characterized in that at least one protective device is disposed at the passage section for maintaining the casing's substantially fluid-tight property in the area of this passage section.

The protective device preferably comprises at least one polymer, preferably polypropylene and/or polyethylene terephthalate. The advantage herein lies in the fact that the protective device can then be provided easily and economically.

One advantage hereby is that due to its chemical and physical properties, it is particularly simple to integrate the polymer into the electrochemical cell. For example, the melting point of polypropylene, subject to its degree of crystallization, is between 130° C. and 171° C. This can be used to an advantage when manufacturing the inventive electrochemical cell and the protective device or its sections comprising polypropylene can subsequently be thermally deformed. It is thereby possible to at least partly dispose the protective device at the conductor device's passage section through the casing—from the interior to the exterior of the casing—and for example thereafter deform it by thermal treatment, for example wholly or partially melt it intermediately. Doing so makes it possible to wholly or partially bond the protective device to e.g. the casing. In addition, protective devices consisting entirely or partially of polypropylene can be economically and expediently manufactured since polypropylene is easily processed, for example in injection molding or deformation procedures.

The chemical and physical properties of polyethylene terephthalate also allow its particularly simple integration into the electrochemical cell. For example, the melting point of polyethylene terephthalate, subject to its degree of crystallization and polymerization, is between 235° C. and 260° C. This can be used to an advantage when manufacturing the inventive electrochemical cell and the protective device or its sections comprising polyethylene terephthalate being formed as fibers or a fibrous web or films and thermally deformed. It is thereby possible to at least partly arrange the protective device at the conductor device's passage section through the casing—from the interior to the exterior of the casing—and for example thereafter deform it by thermal treatment, for example wholly or partially melt it intermediately. Doing so also makes it possible to wholly or partially bond the protective device to e.g. the casing. Protective devices consisting entirely or partially of polyethylene terephthalate can moreover be economically and expediently manufactured.

A further advantage thereby is that using polyethylene terephthalate formed as a fibrous web with polypropylene having been introduced, preferably by extrusion, creates a material which remains stable, dimensionally stable in particular, subsequent deformation and which can be fused or heat-sealed to e.g. the casing comprising a layer comprised of polypropylene, for example. The polypropylene portion of the protective device can above all hereby be bonded, particularly fused or heat-sealed, to the casing's polypropylene-comprising layer, and thus provide a particularly tight sealing of the casing, above all at the point where the conductor device emerges from the casing while the polyethylene terephthalate portion of the protective device above all provides for protecting the casing from damage, particularly from the conductor device.

An electrochemical cell is to be understood as any type of device for electrically storing energy. The term thereby in particular defines electrochemical cells of primary or secondary type, but also other forms of energy stores as well such as capacitors, for example.

An electrode stack comprises at least one cathode, one anode and one separator with electrolyte. An electrode stack is furthermore to be understood as a device which, as a component of an electrochemical cell, also serves in the storing of chemical energy and the emitting of electrical energy. To this end, the electrode stack comprises a plurality of plate-shaped elements, at least two electrodes, the anode and cathode, and a separator, which at least partially absorbs the electrolyte. Preferably, at least one anode, one separator and one cathode are positioned or stacked one upon the other, whereby the separator is at least partially disposed between the anode and cathode. This sequential arrangement of anode, separator and cathode can be repeated within the electrode stack as often as desired. The plate-shaped elements can also be coiled up into an electrode coil. The term electrode stack can also be used for an electrode coil.

Prior to electrical energy being emitted, the stored chemical energy is converted into electrical energy. During the charging process, the electrical energy supplied to the electrode stack, or the galvanic cell respectively, is converted into chemical energy and stored. The electrode stack preferably has multiple pairs of electrodes and separators. It is particularly preferential for some electrodes to be interconnected, particularly electrically. The use of the term electrode stack in the singular does not exclude the fact that the reference can also be referring to a plurality of electrode stacks.

A casing refers to an at least partial delimitation which delimits the electrode stack(s) outwardly. The casing is preferably fluid-tight, i.e. gas-tight and liquid-tight, so that there can be no material exchange with the surroundings. The electrode stacks are disposed within the casing. The expression casing interior thereby preferably refers to the side of the casing facing the electrode stack and the expression casing exterior preferably refers to the side of the casing facing away from the electrode stack.

A conductor device can comprise or consist of at least one current conductor and/or at least one conductor tab. A conductor device serves to conduct current between two points spaced at a distance from one another, for example an electrochemical cell and an electrical load. The conductor device is preferably in contact with the electrode stack. The conductor device preferably extends from the electrode stack into the environment. When there is at least a partial casing around the electrode stack, the conductor device can pass through the casing, preferably from the interior of the casing to the exterior of the casing.

A current conductor is an element manufactured from a conductive material. It serves in conducting current between two geometrically distanced points. In the present case, a current conductor also refers to a device which enables the flow of electrons from one electrode toward an electrical load. The current conductor also works in the opposite direction of current. A current conductor can be electrically connected to an electrode, an active electrode mass respectively, or to the conductor tab(s) of the electrode stack's electrodes and then further to a connecting lead. The design of the current conductor is adapted to the design of the electrochemical cell/electrode stack. A current conductor is of preferably plate-shaped or foil-like design. Each electrode or each conductor tab of the electrode stack preferentially has its own current conductor, respectively electrodes or conductor tabs of like polarity are connected to a common current conductor. A current conductor can create a conductive connection between two electrode stacks. The at least one current conductor is preferably also connected to a conductor tab in heat-conducting manner. The current conductor can preferably have a heat-conducting and/or electroconductive connection to at least one conductor tab.

A conductor tab is connected to an electrode stack. In particular, the conductor tab is thereby connected to all of an electrode stack's like electrodes, i.e. either to the cathodes or to the anodes. Obviously, a conductor tab is not concurrently connected to the electrode stack's cathodes and anodes since doing so would cause a short circuit. However, a conductor tab can be connected to different electrodes of different electrode stacks; thus in the case of a series connection of two electrode stacks, for example. The conductor tab can be integrally formed with one or more electrodes. A delimitation between conductor tab and electrode can be seen in the conductor tab particularly not being coated with active electrode material. The conductor tab can be of an electrically and/or thermally conductive material, preferably aluminum or copper, of one-piece or multi-piece design, respectively single-layered or multi-layered.

The protective device is preferably at least partially arranged between the casing and the conductor device. This arrangement advantageously reduces, preferably minimizes, preferentially prevents the conductor device from damaging the casing.

The electrode stack preferably comprises a plurality of, at least two, cathodes, anodes and separators. It is further preferable for the electrode stack to comprise a plurality of, at least ten, anodes, cathodes and separators. Further preferential is for the electrode stack to comprise 30 cathodes and anodes and 60 separators. Cathode(s), anode(s) and separator(s) are in each case of plate-shaped configuration.

A conductor device preferably at least partially comprises electroconductive material, preferably electrically as well as thermally conductive, particularly copper and/or aluminum. The design of the conductor device is preferably adapted to the design of the electrochemical cell or electrode stack respectively. It is preferential for the conductor device to exhibit a foil-like or plate-like design or for the conductor device to at least partially comprise plate-shaped or foil-shaped elements. The conductor device is preferably of multi-piece configuration, preferably comprising conductor tab(s) and current conductors affixed thereto, preferably by ultrasonic welding. The conductor device can, however, preferably also be of one-piece design. The conductor device preferably has components within and/or external of the casing. The conductor device preferably has components between a first casing and a second casing.

The protective device is preferably at least partly or wholly of foil-like configuration, preferably an adhesive film. The adhesive film is in particular at least one adhesive strip. At least part of at least one adhesive strip is thereby disposed on the conductor device and/or the casing and/or between the conductor device and casing, particularly in a bonded, force-fit and/or form-fit connection, particularly at the section where the conductor device passes through the casing. An adhesive deposited on a carrier can be an adhesive strip. The carrier preferably comprises polypropylene and/or polyethylene terephthalate. It is further preferential for the carrier to at least partially comprise polyethylene terephthalate preferably at least partially configured as a fibrous web and which preferably comprises polypropylene preferably introduced into the polyethylene terephthalate. Said introducing can preferably be realized by extrusion. However, other methods suited to the purpose can also be employed. Acrylate adhesives or silicone adhesives are preferably employed as the adhesive. The adhesive can be applied to one or both sides of the carrier. The adhesive strips are preferably disposed such that the side of the carrier coated with the adhesive faces the conductor device. The side coated with adhesive can, however, preferably also face the casing.

The protective device is preferentially designed as at least one adhesion point. An adhesion point is preferably a plate-like element, the surface of which is very small compared to the surface of the electrode stack, in particularly by a factor of 50, 100, 200 or 500 times smaller than the surface of the electrode stack. An adhesion point is easily affixed to well-defined locations and also provides appropriate protection against the casing being damaged. A plurality of adhesion points are preferably affixed along the passage section of the conductor device through the casing. An adhesion point is preferably at least partly designed as a body composed preferably at least partially or preferably mostly or preferably entirely of polyethylene terephthalate and/or polypropylene and which can be at least partially coated on the surface with an adhesive, preferably an acrylate adhesive or a silicone adhesive. It is further preferential for the adhesion point to be at least partially comprised of polyethylene terephthalate which is preferably at least partially configured as a fibrous web and which preferably comprises polypropylene preferably introduced into the polyethylene terephthalate. Said introducing can preferably be realized by extrusion. However, other methods suited to the purpose can also be employed.

In one preferential embodiment of the invention, the protective device is designed as an adhesive bead. An adhesive bead is preferably an elongated, plate-like component, the length of which is greater than its width by a factor of at least 2, 5, 10, 50 or 100. At least part of at least one adhesive bead is preferably disposed on the conductor device and/or the casing, preferably at least partly between the conductor device and casing, particularly at the section the conductor device passes through the casing. An adhesive bead is preferably at least partly designed as a body composed preferably at least partially or preferably mostly or preferably entirely of polyethylene terephthalate and/or polypropylene and which can be at least partially coated on the surface with an adhesive, preferably an acrylate adhesive or a silicone adhesive. It is further preferential for the adhesive bead to be at least partially comprised of polyethylene terephthalate which is preferably at least partially configured as a fibrous web and which preferably comprises polypropylene preferably introduced into the polyethylene terephthalate. Said introducing can preferably be realized by extrusion. However, other methods suited to the purpose can also be employed.

The protective device is preferably of one-piece or multi-piece design. Multiple components of at least one protective device or a plurality of protective devices can preferably be distanced from one another. Preferentially, multiple components of at least one fixing device or a plurality of fixing devices can be in contact with one another, particularly joined together in a form-fit and/or force-fit and/or bonded connection. The protective device is preferentially of flexible or rigid design, or can comprise flexible and/or rigid components. At least part of the protective device preferably comprises a polymer, preferably polypropylene and/or polyethylene terephthalate. It is further preferential for the protective device to be at least partially comprised of polyethylene terephthalate which is preferably at least partially configured as a fibrous web and which preferably comprises polypropylene preferably introduced into the polyethylene terephthalate. Said introducing can preferably be realized by extrusion. However, other methods suited to the purpose can also be employed. Preferably, at least part of the protective device can thereby advantageously be connected to the casing and/or to the conductor device in a form-fit and/or force-fit and/or bonded connection, a material bond particularly, preferably by fusing. The protective device can preferably comprise at least partly electrically conductive components, for example made of metal, or electrically conductive carbon.

In one preferential embodiment of the invention, the electrochemical cell comprises an electrode stack, a casing or packing of the electrode stack and electrical connections, particularly at least one conductor device and/or current conductor and/or conductor tabs to the electrodes. The casing also separates the electrode stack from the surroundings and prevents electrolyte from leaking out. When the electrochemical cell comprises two electrode stacks connected in series, two conductor devices of different electrode stacks can then be connected together.

The casing preferably comprises at least two casing parts, a first casing part and a second casing part. The first casing part can preferably wholly or preferably partially encase the second casing part. The first and the second casing part can preferably be contiguous. The first casing part and the second casing part can preferably be at least partially joined in a form-fit and/or force-fit and/or material bond so as to at least partially enclose the electrode stack. Preferably, the casing parts fit snugly against at least one electrode stack, at least partially. The casing parts can preferably have the same or differing properties, for example the first casing part can have good heat conduction properties and the second casing part can have good insulating properties. At least parts of the casing parts can comprise or be made from the same or different materials. The casing can be at least partially of foil-like design. Preferably, the casing consists at least partially of composite material.

The casing is particularly preferably of one-piece design. The interior of the casing preferably consists at least partially of composite material comprising at least one polymer, preferably polypropylene. This does not exclude the interior of the casing from being comprised of only one material or of only one-piece design. Instead, it is preferably also conceivable for the interior of the casing to be of multi-part design, which also includes a multi-layer design such as in the case of a composite material, and for the interior of the casing to comprise at least two materials, for example at least two polymers, or at least one polymer and at least one metal. The exterior of the casing preferably consists at least partially of a composite material. This does not exclude the exterior of the casing from being comprised of only one material or of only one-piece design. Instead, it is preferably also conceivable for the exterior of the casing to be of multi-part design, which also includes a multi-layer design such as in the case of a composite material, and for the exterior of the casing to comprise at least two materials, for example at least two polymers, or at least one polymer and at least one metal. The interior and the exterior of the casing preferably consist of the same material, preferably a composite material.

At least one conductor device and particularly two conductor devices preferably extend out from the interior of the casing to the exterior of the casing. The outward extending conductor devices can thereby preferably constitute the electrical connections, e.g. the positive terminal connection and the negative terminal connection of the electrochemical cell or battery. However, a plurality of conductor devices, particularly four conductor devices, can also extend out of the casing.

In accordance with the invention, a method of assembling the electrochemical cell is also proposed which comprises the following preferentially optional method steps which can be performed in any order.

The protective device is preferably arranged on the conductor device. This arrangement can ensue by means of joining the conductor device to the protective device in a material and/or form-fit and/or force-fit bond. A material bond is particularly preferential. An adhesive bond is likewise particularly preferential. It is also preferential to treat the surface of the conductor device, for example by distressing the surface or making a recess or opening in the surface in order to enable a better bond with the protective device. The protective device is preferably arranged on the casing. This arrangement can ensue by means of joining the casing to the protective device in a material and/or form-fit and/or force-fit bond. A material bond is particularly preferential, particularly one made by heat-sealing or fusing.

It is also preferential to treat the surface of the casing, for example by distressing the surface or making a recess in the surface in order to enable a better bond with the protective device. After being arranged on the conductor device, the protective device is preferably joined to the casing in a material and/or force-fit and/or form-fit bond, particularly a material bond, preferably by fusing or heat-sealing, so that the protective device is thereafter at least partially disposed between the conductor device and the casing, particularly at the conductor device's passage section through the casing, particularly material bonded to both. After being arranged on the casing, the protective device is preferably joined to the conductor device in a material and/or force-fit and/or form-fit bond, particularly a material bond, preferably by fusing or heat-sealing, so that the protective device is thereafter at least partially disposed between the conductor device and the casing, particularly at the conductor device's passage section through the casing, particularly material bonded to both.

The casing thereby preferably seals the electrode stack it contains in fluid-tight manner against the environment, with a hermetic seal being particularly preferential. Hermetic means that there can be no non-destructive exchange of material or gas between the casing and the content of the casing, for example the electrode stack and/or electrolyte. This is preferably achieved by the casing tightly sealing the electrode stack, including around the conductor device. This is preferably realized by using a protective device comprising at least one polymer, preferably a polyterephthalate fibrous web comprising polypropylene extruded therein, and a casing, the side of which facing the protective device comprises at least one polymer, preferably polypropylene. This provides the advantage of the casing and the protective device being able to be heat-sealed and/or fused together, particularly in a material bond.

The protective device can be disposed on the conductor device and/or casing in solid form, for example as a fully finished protective device, e.g. an adhesive tape. It is however also possible for the protective device to be disposed on the conductor device and/or casing in non-solid form, for example as a precursor to the fully finished protective device, e.g. a liquid which still needs to harden or dry.

The following description provided in conjunction with the figures will yield further advantages, features and conceivable applications of the present invention.

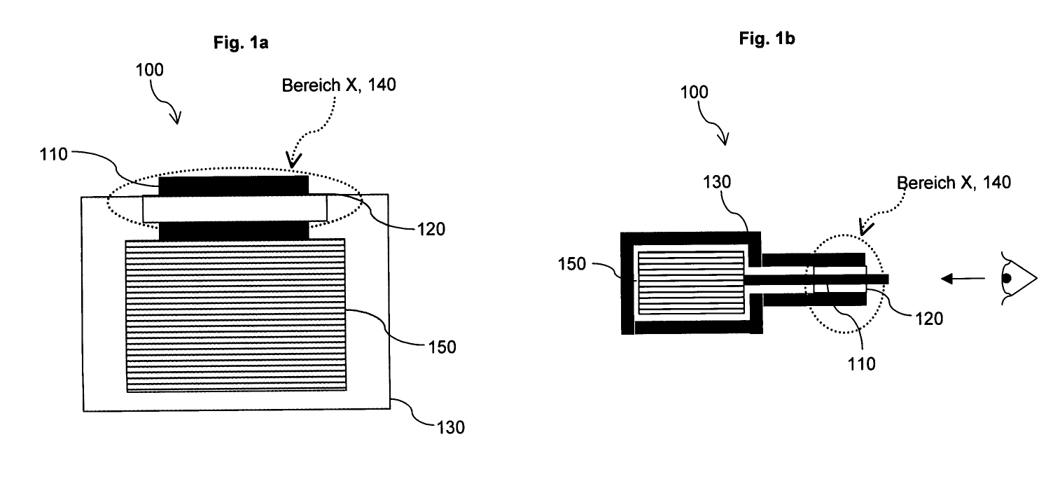

FIG. 1a is a schematic view of an embodiment of the inventive electrochemical cell from above;

FIG. 1b is a schematic cross section of an embodiment of the inventive electrochemical cell;

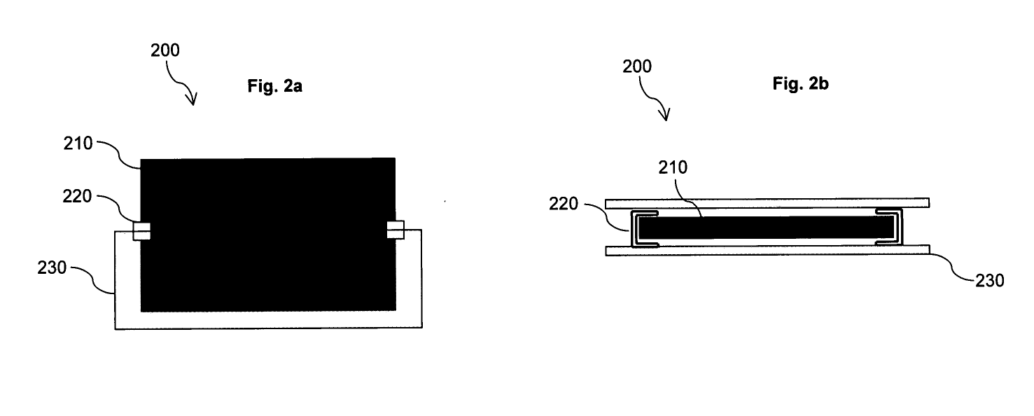

FIG. 2a is a schematic view from above showing an enlargement of region X from FIG. 1a of an embodiment of the inventive electrochemical cell;

FIG. 2b is a schematic cross section showing an enlargement of region X from FIG. 1b of an embodiment of the inventive electrochemical cell;

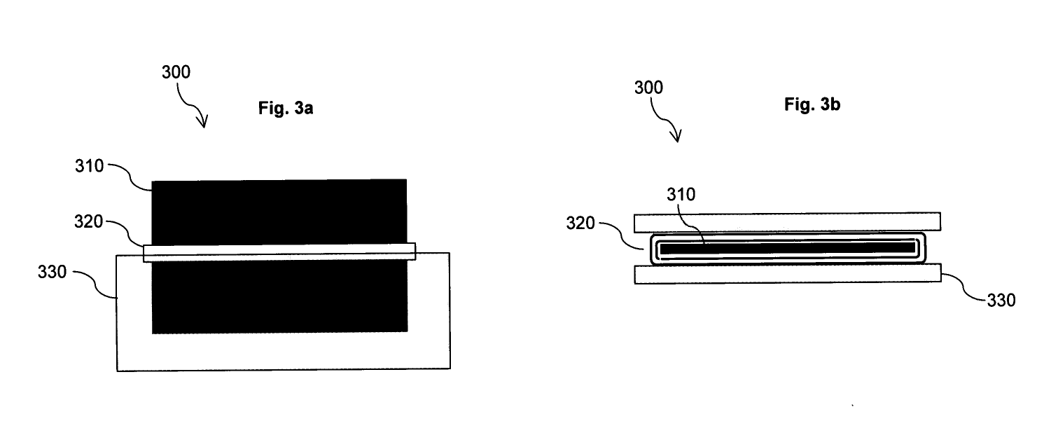

FIG. 3a is a schematic view from above showing an enlargement of region X from FIG. 1a of an embodiment of the inventive electrochemical cell;

FIG. 3b is a schematic cross section showing an enlargement of region X from FIG. 1b of an embodiment of the inventive electrochemical cell;

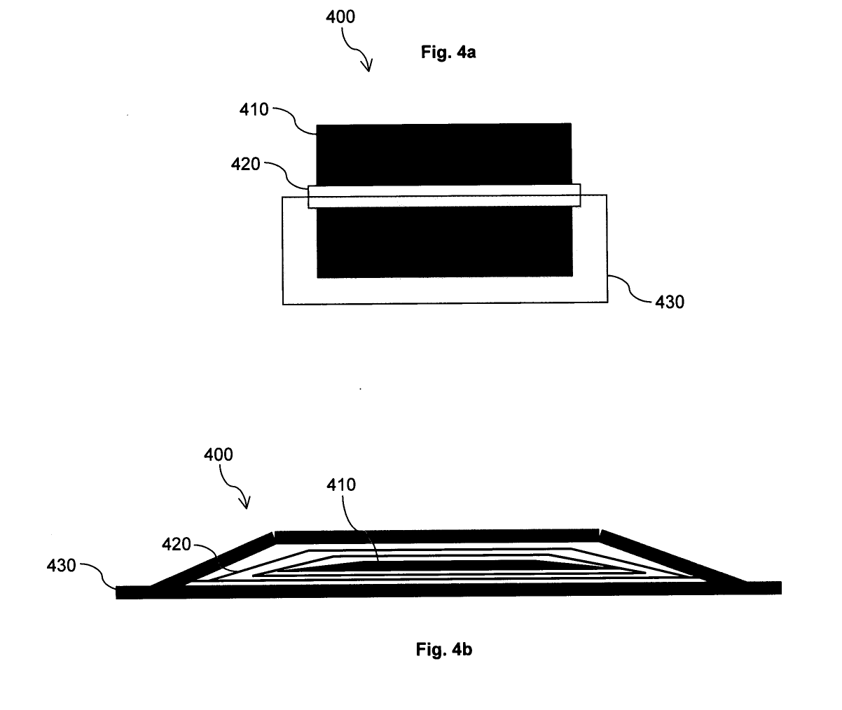

FIG. 4a is a schematic view from above showing an enlargement of region X from FIG. 1a of an embodiment of the inventive electrochemical cell;

FIG. 4b is a schematic cross section showing an enlargement of region X from FIG. 1b of an embodiment of the inventive electrochemical cell;

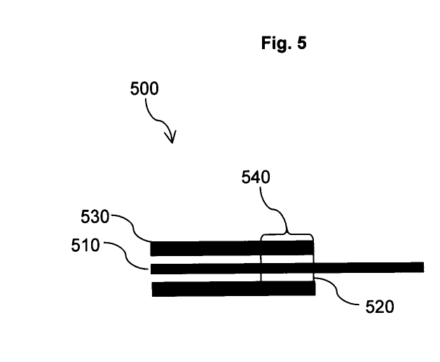

FIG. 5 is the schematic cross section of an enlargement of region X from FIG. 1b of an embodiment of the inventive electrochemical cell; and

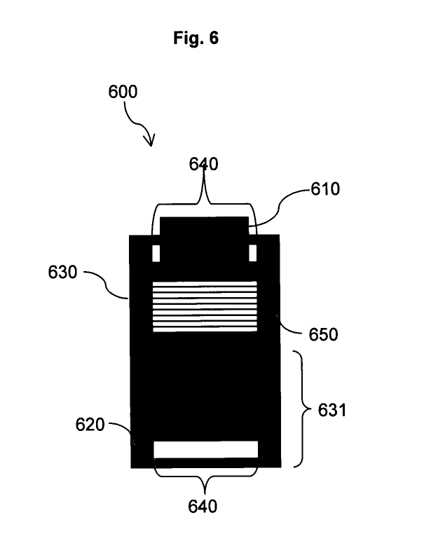

FIG. 6 is a schematic view from above showing an enlargement of region X from FIG. 1a on an embodiment of the inventive electrochemical cell.

In accordance with FIGS. 1a and 1b, an embodiment of an electrochemical cell 100 comprises an electrode stack 150, a casing 130, a conductor device 110 and a protective device 120. The conductor device 110 passes through the casing 130 at a passage section 140. In the present embodiment, the passage section 140 corresponds to region X, which is shown in enlarged views in the subsequent FIGS. 2a/b to FIG. 5. The line of sight in the schematic cross sections of the embodiment depicted in FIGS. 2b, 3b and 4b corresponds to that of FIG. 1b.

In accordance with FIGS. 2a and 2b, an embodiment of an electrochemical cell 200 comprises a conductor device 210 with a protective device 220 arranged at its edges. The casing 230 only partly covers the protective device 220. The casing 230 can, however, also completely cover the protective device 220.

In accordance with FIGS. 3a and 3b, an embodiment of an electrochemical cell 300 comprises a casing 330 and a conductor device 310 with a protective device 320 arranged at its side wrapped around by the conductor device 310. The protective device 320 can for example comprise another material at that point where the protective device 320 contacts the edges of the conductor device 310, for example it can be reinforced with metal.

In accordance with FIGS. 4a and 4b, an embodiment of an electrochemical cell 400 comprises a casing 430 and a conductor device 410, the edges of which taper and thus exhibit a trapezoidal form. The protective device 420 can consist of two parts, wherein a first part extends along the principal baseline side of the trapezoidal conductor device 410 and a second part of the protective device 420 extends along the sides and the second baseline of the trapezoidal conductor device 410, conjoining the first part at the height of the principal baseline.

According to FIG. 5, one embodiment of an electrochemical cell 500 has a passage section 540 for a conductor device 510 through the casing 530 comprising a protective device 520. The protective device 520 can be partly arranged between the conductor device 510 and the casing 530.

In accordance with FIG. 6, an embodiment of an electrochemical cell 600 comprises an electrode stack 650, a conductor device 610 and protective devices 620 disposed on the casing 630. The region in which the protective devices 620 are arranged on the casing 530 defines the passage section 640 for the conductor device 610 through the casing 630. It is also possible for only one protective apparatus to be affixed to the casing which is then later penetrated by the conductor device. The embodiment of an electrochemical cell 600 depicted in FIG. 6 shows a conceivable snapshot at a given instant during assembly of the electrochemical cell 600 at which the electrode stack 650 and the conductor device 610 are not yet covered by a part of the casing 631.

### LIST OF REFERENCE NUMERALS

Electrochemical cell: 100, 200, 300, 400, 500, 600

Conductor device: 110, 210, 310, 410, 510, 610

Protective device: 120, 220, 320, 420, 520, 620

Casing: 130, 230, 330, 430, 530, 630

Casing part: 631

Passage section: 140, 540, 640

Electrode stack: 150, 650

1-15. (canceled)

16. An electrochemical cell comprising:
at least one electrode stack having at least one conductor device and at least one casing which at least partially encases the electrode stack and which has at least one passage section through which the at least one conductor device passes from the interior to the exterior of the casing, wherein at least one protective device is disposed at the at least one passage section to maintain a substantially fluid-tight property of the casing in the area of said passage section, and wherein the protective device comprises polyethylene terephthalate configured as a fibrous web, and polypropylene introduced into said polyethylene terephthalate.

17. The electrochemical cell according to claim 16, wherein the protective device is at least partially configured in a foil-like design.

18. The electrochemical cell according to claim 17, wherein the protective device is at least partially configured as an adhesive tape.

19. The electrochemical cell according to claim 16, wherein the protective device is at least partially arranged between the casing and the conductor device.

20. The electrochemical cell according to claim 16, wherein the protective device is at least partially bonded to the conductor device.

21. The electrochemical cell according to claim 16, wherein the protective device comprises at least one polymer.

22. The electrochemical cell according to claim 16, wherein the casing at least partially comprises a composite material comprising at least one layer closest to the protective device which at least partially consists of polypropylene.

23. The electrochemical cell according to claim 16, wherein the protective device is at least partially joined to the casing in a bonded and/or force-fit and/or form-fit connection.

24. The electrochemical cell according to claim 22, wherein the protective device is finally bonded to the casing by heat-sealing or melting the polypropylene of the protective device to the layer of the casing closest to said protective device.

25. A method for manufacturing an electrochemical cell comprising at least one electrode stack having at least one conductor device and at least one casing which at least partially encases the electrode stack, the method comprising:
arranging at least one protective device at a passage selection through which a conductor device passes from the interior to the exterior of the casing, wherein the at least one protective device is suited to maintain a substantially fluid-tight property of the casing in the area of said passage section, and wherein the protective device comprises polyethylene terephthalate configured as a fibrous web and polypropylene introduced into said polyethylene terephthalate.

26. The method according to claim 25, wherein the at least one protective device is at least partially bonded to the conductor device in the area of the passage section.

27. The method according to claim 25, wherein the at least one protective device is at least partially joined to the casing in the area of the passage section in a bonded and/or force-fit and/or form-fit connection.

28. The method according to claim 27, wherein the at least one protective device is at least partially heatsealed or melted to the casing in the area of the passage section.

29. The method according to claim 25, wherein the at least one protective device is at least partially configured in a foil-like design.
